(19) United States
(12) Patent Application Publication
(10) Pub. No.: US 2020/0042886 A1
(43) Pub. Date: Feb. 6, 2020

(54) INFORMATION OUTPUT SYSTEM, INFORMATION OUTPUT METHOD, AND RECORDING MEDIUM

(71) Applicant: NEC Corporation, Tokyo (JP)

(72) Inventor: Hiroki NAKAYAMA, Tokyo (JP)

(73) Assignee: NEC Corporation, Tokyo (JP)

(21) Appl. No.: 16/601,880

(22) Filed: Oct. 15, 2019

Related U.S. Application Data
(63) Continuation of application No. 16/315,223, filed on Jan. 4, 2019.

(30) Foreign Application Priority Data
Jul. 11, 2016 (JP) 2016-136828

(51) Int. Cl. G06N 5/04; G06Q 50/26

(52) U.S. Cl. CPC G06N 5/04; G06F 17/2785; G06Q 50/26

(57) ABSTRACT

An information output system for leading a person in such a way as to rapidly achieve a predetermined state for investigation of crime using communication means is provided. An information output system 200 includes an identification unit 220, a storage unit 230, and an output unit 250. The identification unit 220 identifies an observed state, based on information indicating a message from a person. The storage unit 230 stores knowledge information to be used for reasoning of a target state being a predetermined state for investigation. The output unit 250 performs reasoning, based on observation information indicating the observed state and the knowledge information, and outputs information indicating a message to be spoken or sent by the person.

The present application is a Continuation application of Ser. No. 16/315223 filed on Jan. 4, 2019, which is a National Stage Entry of PCT/JP2017/024883 filed on Jul. 7, 2017, which claims priority from Japanese Patent Application 2016-136828 filed on Jul. 11, 2016, the contents of all of which are incorporated herein by reference, in their entirety.

### TECHNICAL FIELD

The present invention relates to an information output system, an information output method, and a recording medium.

### BACKGROUND ART

As crime using communication means, cases where a suspect makes contact with a victim and commits various types of crime such as a fraud, fraudulent solicitation, and a threat, using communication means such as a telephone, e-mail, a messaging service, and a social network service (SNS), are known. For such crime using communication means, a technique for detecting crime, based on communicated information is known. For example, PTL 1 discloses a technique for detecting a fraud using a telephone call, based on a frequency of a word registered in a database during a telephone call.

Note that, as a related technique, NPL 1 discloses text implication recognition that determines whether two sentences include the same meaning. NPL 2 discloses an example of a system for presenting an answer to a question by using a result of machine learning. NPL 3 discloses a technique for learning a model to determine semantic identity between documents.

### CITATION LIST

### Patent Literature

[PTL 1] Japanese Patent Application Laid-Open Publication No. 2012-156664

[Non Patent Literature]

[NPL 1] “Text Analysis Technology”, [online], [Retrieved on Jun. 10, 2016], Internet <URL: http://jpn.nec.com/rd/research/DataAnalytics/textmining.html>

[NPL 2] “IBM Watson”, [online], [Retrieved on Jun. 10, 2016], Internet <URL: http://www.ibm.com/smarterplanet/jp/ja/ibmwatson>

[NPL 3] Bin Bai, et.al, “Supervised Semantic Indexing”, Proceedings of the 18th ACM conference on Information and knowledge management, pp.187-196, 2009

### SUMMARY OF INVENTION

### Technical Problem

In order to rapidly start an investigation and arrest the suspect when crime using the above-described communication means occurs, a victim needs to have an appropriate conversation with a suspect and acquire information for the investigation as much as possible, for example. However, the above-cited documents do not disclose a technique for acquiring information that leads to start of the investigation.

An example object of the present invention is to provide an information output system, an information output method, and a recording medium that are capable of solving the above-described problem and leading a person in such a way as to rapidly achieve a predetermined state for investigation, such as a state where information needed for the investigation is acquired, for crime using communication means.

### Solution to Problem

An information output system according to an exemplary aspect of the present invention includes: identification means for identifying an observed state, based on information indicating a message from a person; storage means for storing knowledge information to be used for reasoning of a target state being a predetermined state for investigation; and output means for performing reasoning, based on observation information indicating the observed state and the knowledge information, and outputting information indicating a message to be spoken or sent by the person.

An information output method according to an exemplary aspect of the present invention includes: identifying an observed state, based on information indicating a message from a person; storing knowledge information to be used for reasoning of a target state being a predetermined state for investigation; and performing reasoning, based on observation information indicating the observed state and the knowledge information, and outputting information indicating a message to be spoken or sent by the person.

A computer readable storage medium according to an exemplary aspect of the present invention records thereon a program causing a computer to perform a method including: identifying an observed state, based on information indicating a message from a person; storing knowledge information to be used for reasoning of a target state being a predetermined state for investigation; and performing reasoning, based on observation information indicating the observed state and the knowledge information, and outputting information indicating a message to be spoken or sent by the person.

### Advantageous Effects of Invention

An advantageous effect according to the present invention is to enable leading a person in such a way as to rapidly achieve a predetermined state for investigation of crime using communication means.

### BRIEF DESCRIPTION OF DRAWINGS

FIG. 1 is a block diagram illustrating a characteristic configuration of a first example embodiment of the present invention.

FIG. 2 is a block diagram illustrating a configuration of the first example embodiment of the present invention.

FIG. 3 is a block diagram illustrating a configuration of an information output system 200 implemented on a computer in the first example embodiment of the present invention.

FIG. 4 is a flowchart illustrating operation in the first example embodiment of the present invention.

FIG. 5 is a diagram illustrating an example of domain knowledge information in the first example embodiment of the present invention.

FIG. 6 is a diagram illustrating an example of a display screen of an output device 300 in the first example embodiment of the present invention.

FIG. 7 is a block diagram illustrating a configuration of a second example embodiment of the present invention.

FIG. 8 is a flowchart illustrating details of reasoning processing (Step S104) in the second example embodiment of the present invention.

FIG. 9 is a diagram illustrating an example of domain knowledge information in the second example embodiment of the present invention.

FIG. 10 is a diagram illustrating an example of generating a rule candidate related to the domain knowledge information in the second example embodiment of the present invention.

FIG. 11 is a diagram illustrating an example of selecting a new rule related to the domain knowledge information in the second example embodiment of the present invention.

FIG. 12 is a flowchart illustrating details of reasoning processing (Step S104) in the second example embodiment of the present invention.

FIG. 13 is a diagram illustrating an example of general-purpose knowledge information in a third example embodiment of the present invention.

FIG. 14 is a diagram illustrating an example of generating a rule candidate related to the general-purpose knowledge information in the third example embodiment of the present invention.

FIG. 15 is a diagram illustrating an example of selecting a new rule related to the general-purpose knowledge information in the third example embodiment of the present invention.

### EXAMPLE EMBODIMENT

Example embodiments of the invention is described in detail with reference to drawings. Note that, similar components have the same reference numeral in each of the drawings and each of the example embodiments in the specification, and description thereof is appropriately omitted.

In the example embodiments of the present invention, a case where crime to be investigated is a fraud that requests, via telephone call, a cash delivery or a money transfer (hereinafter also referred to as a special fraud) is described as an example.

### First Example Embodiment

A first example embodiment of the present invention is described.

First, “reasoning” in the example embodiments of the present invention is described. The reasoning is performed by using knowledge information. The knowledge information is a set of known rules (hereinafter also described as pieces of knowledge) between states. For example, like “x asks y”, a state is expressed by a predicate (in this case ‘ask’) and an argument (in this case, ‘x’ and ‘y’) for which a state is described. For example, a rule has a format such as “if state ‘a’ is true (premise), then state ‘b’ is true (result)”. The rule represents an implication relation, a cause-and-effect relation, a context, an If-Then relation, or the like between states. A rule “if state ‘a’ is true, then state ‘b’ is true” is also described as a rule ‘a→b’. In this case, the states ‘a’ and ‘b’ are also described as “states related to rule ‘a→b’”. Further, the rule ‘a→b’ is also described as “a rule related to state ‘a’” or “a rule related to state ‘b’”.

Further, by using knowledge information, it is possible to acquire a series of rules (hereinafter also referred to as a rule series, a knowledge series, or a directed graph) that is reachable to a state being a target (hereinafter also referred to as a target state or a query) from a given state. In the example embodiments of the present invention, acquiring a rule series that is reachable to the target state from a state being actually observed (hereinafter also referred to as an observed state) based on the knowledge information is referred to as “reasoning”.

Further, in the example embodiments of the present invention, knowledge information for a specific region is referred to as domain knowledge information

It is assumed in the first example embodiment of the present invention that occurrence of crime to be investigated (special fraud) is known, and domain knowledge information for investigation of the crime to be investigated (investigation of special fraud) is set.

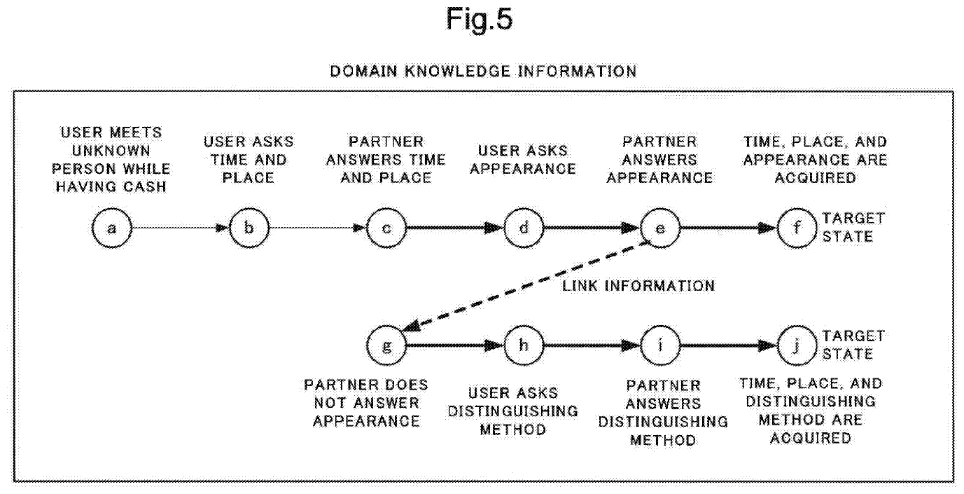

FIG. 5 is a diagram illustrating an example of the domain knowledge information in the first example embodiment of the present invention. In FIG. 5, a circle indicates a state. An arrow with a solid line between circles indicates a rule between a state at an arrow head and a state at an arrow tail. The state at an arrow head is a premise, and the state at an arrow tail is a result. A reference sign inside a circle indicates an identifier of a state.

In the domain knowledge information, “a state where information needed for investigation is acquired (state where the investigation can be started)” is set as a target state. Further, a state related to each of rules includes a state related to a message spoken by a user being a person, or a message spoken by a communication partner being another person (hereinafter also simply referred to as a partner). The state may include a state related to behavior of the user or the partner acquired from a message from the user or the partner. Further, the rule may be set in such a way as to being reachable to the target state (state where information needed for investigation is acquired) in a natural conversation (without being noticed to the partner) when the user or the partner speaks in an order of rules in a rule series acquired by reasoning.

In the domain knowledge information in FIG. 5A, state ‘f’ where “time, place, and appearance are acquired” is set as a target state. Further, rules are set in such a way that a rule series ‘a→b→c→d→e→f’ that is reachable to the target state ‘f’ passing through a state ‘c’ where “partner answers time and place” and a state ‘e’ where “partner answers appearance” is acquired.

Further, in a rule series, a series of necessary rules (hereinafter referred to as a necessary rule series) that needs to be passed in order to reach a target state may be further set.

In FIG. 5, a series of rules indicated by arrows with thick solid lines represents a necessary rule series. Herein, a rule series ‘c→d→e→f’ is set as the necessary rule series for reaching the target state ‘f’.

By performing reasoning with the domain knowledge information and outputting a message to be spoken by a user according to the rule series acquired by the reasoning, it is possible to lead a message from the user in such a way that information needed for investigation is acquired.

Further, link information for associating with another rule series may be set to some states in the rule series. The link information indicates another rule series to be used after the state, when a message from a user or a partner is different from the state in the rule series.

In FIG. 5, an arrow with a dotted line between circles indicates association by the link information. Herein, a state ‘j’ where “time, place, and distinguishing method are acquired” is further set as a target state. Further, rules are set in such a way that a rule series “g→h→i→j” being reachable to the target state “j” is acquired. Herein, a distinguishing method is a method for identifying a partner to which cash is delivered by using other than appearance, and is, for example, a telephone number for making contact with the partner when arriving at a place acquired from the partner.

By outputting a message to be spoken by the user according to another rule series indicated by the link information, it is possible to lead a message from the user in such a way that information needed for investigation is acquired, even when a message from the user or the partner does not follow the rule series.

Note that, a state and a rule in the domain knowledge information are described in, for example, a first-order predicate logic. Further, as long as a relationship such as “if state ‘a’ is true, then state ‘b’ is true” described above can be treated as a relationship between states, a state and a rule may be described in a prepositional logic, a higher-order predicate logic, or another format.

Next, a configuration of the first example embodiment of the present invention is described. FIG. 2 is a block diagram illustrating a configuration of the first example embodiment of the present invention. With reference to FIG. 2, the configuration of the first example embodiment of the present invention includes an input device 100, an information output system 200, and an output device 300. The information output system 200 is connected to the input device 100 and the output device 300 with a network and the like.

The input device 100 is a telephone, such as a fixed-line telephone, a mobile telephone, and a smartphone. The input device 100 inputs voice data during a telephone call between a user of the telephone and a communication partner on the telephone call with the telephone to the information output system 200. Herein, the user and the partner respectively correspond to a victim and a suspect in the above-described special fraud. Note that, as long as voice data during a telephone call between the user and the partner can be acquired, the input device 100 may be a network apparatus such as a switchboard, a voice server, a router, and a switch.

The information output system 200 performs reasoning, based on an observed state acquired from input voice data and domain knowledge information, and outputs to the output device 300 information indicating a message to be spoken by the user.

The information output system 200 includes an analysis unit 210, an identification unit 220, a storage unit 230, and an output unit 250.

The storage unit 230 stores domain knowledge information. The domain knowledge information is input by an administrator or the like and stored in the storage unit 230, beforehand, for example.

The analysis unit 210 converts voice data input from the input device 100 into text by using a voice recognition technique, and extracts a natural sentence (hereinafter also simply referred to as a sentence) indicating an utterance (hereinafter also referred to as a message) of the user or the communication partner on the telephone call. Further, the analysis unit 210 identifies a person (the user or the communication partner) who speaks each extracted sentence, and provides the identified person to the sentence.

The identification unit 220 identifies an observed state that is a state indicated by the sentence extracted by the analysis unit 210 in the domain knowledge information, and generates observation information indicating the observed state. Herein, the identification unit 220 may identify, every time a sentence is extracted, the observed state corresponding to the sentence, or may identify, every time a speaker changes, the observed state corresponding to a message from the speaker.

The output unit 250 performs reasoning by using the observation information and the domain knowledge information, and acquires a rule series being reachable to a target state. The output unit 250 determines, every time the observed state is identified, whether the observed state is identical to a state acquired in order toward the target state in the rule series. When the next state following the observed state is a state related to a message from the user in the rule series, the output unit 250 decides information indicating a message to be spoken by the user, based on the state, and outputs the information to the output device 300. Note that, the output unit 250 may include a reasoning unit (not illustrated) that performs reasoning and acquires a rule series, and an information output unit (not illustrated) that decides information indicating a message to be spoken by the user and outputs the information.

The output device 300 is, for example, a display device such as a display installed around the input device 100. The output device 300 displays the information, which is output from the information output system 200, indicating a message to be spoken by the user, to the user. Note that, the output device 300 may output the information indicating a message to be spoken by the user by a method other than displaying, such as outputting voice with a small volume not being heard by the partner.

The information output system 200 may be a computer that includes a central processing unit (CPU) and a storage medium that stores a program, and operates by control based on the program.

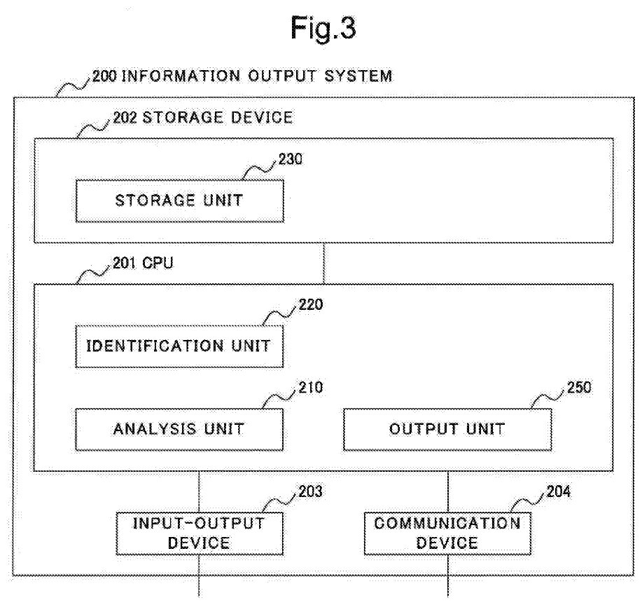

FIG. 3 is a block diagram illustrating a configuration of the information output system 200 implemented on a computer in the first example embodiment of the present invention.

In this case, the information output system 200 includes a CPU 201, a storage device 202 (storage medium) such as a hard disk and a memory, an input-output device 203 such as a keyboard and a display, and a communication device 204 that communicates with another device and the like. The CPU 201 executes a program for implementing the analysis unit 210, the identification unit 220, and the output unit 250. The storage device 202 stores data (domain knowledge information) in the storage unit 230. The input-output device 203 accepts inputs of domain knowledge information and a target state from the administrator or the like. The communication device 204 receives voice data from the input device 100.

Further, the communication device 204 transmits information indicating a message to be spoken by the user to the output device 300.

Further, a part or the whole of each of the components of the information output system 200 may be implemented on general-purpose or dedicated circuitry, a processor, and a combination thereof. The circuitry and the processor may be formed by a single chip or formed by a plurality of chips connected to one another via a bus. Further, a part or the whole of each of the components of the information output system 200 may be implemented by a combination of the above-described circuitry and the like and a program.

When a part or the whole of each of the components of the information output system 200 is implemented on a plurality of information processing devices, circuitry, and the like, the plurality of information processing devices, the circuitry, and the like may be arranged in a concentrated manner or a distributed manner. For example, the information processing devices, the circuitry, and the like may be implemented as a form in which they are connected via a communication network, such as a client server system or a cloud computing system.

Further, a part or the whole of the input device 100, the information output system 200, and the output device 300 may be configured by one device. For example, the information output system 200 may be included in a telephone. Further, the input device 100, the information output system 200, and the output device 300 may be included in a telephone. Further, the input device 100 and the output device 300 may be included in a telephone, and the information output system 200 may be implemented on a server (computer) connected to the telephone via a network.

Next, operation in the first example embodiment of the present invention is described.

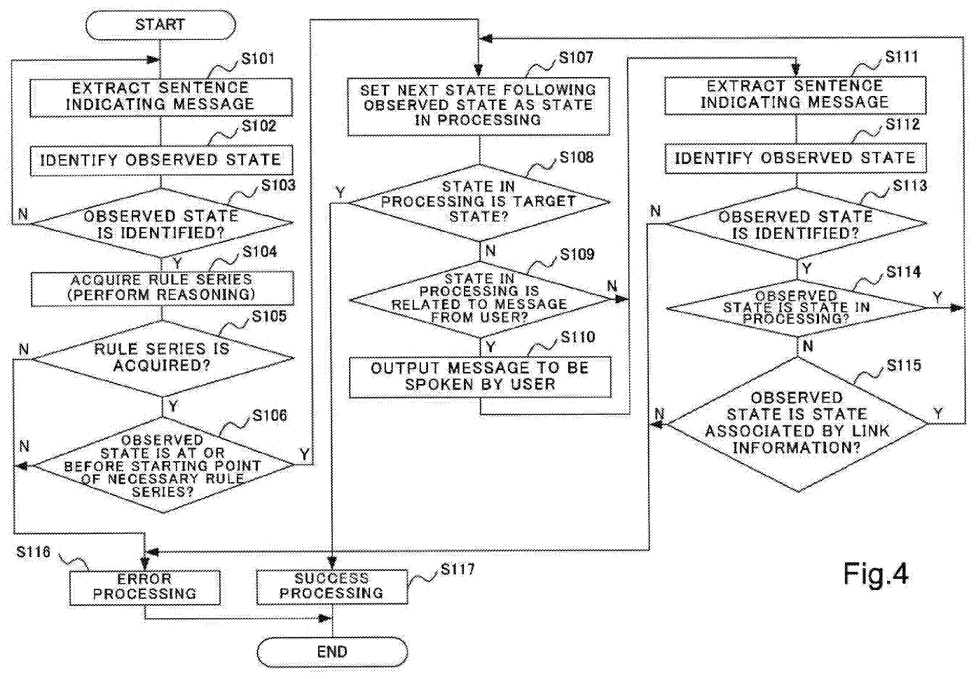

FIG. 4 is a flowchart illustrating the operation in the first example embodiment of the present invention.

First, the analysis unit 210 of the information output system 200 converts voice data input from the input device 100 into text, and extracts a sentence indicating a message from a user or a communication partner (Step S101).

The identification unit 220 identifies an observed state in domain knowledge information, based on the sentence extracted by the analysis unit 210 (Step S102).

When an observed state is not identified in Step S102 (N in Step S103), the processing from Step S101 is repeated.

When an observed state is identified in Step S102 (Y in Step S103), the output unit 250 acquires a rule series being reachable to a target state from the observed state (performs reasoning), based on the domain knowledge information (Step S104). Herein, when the acquired rule series includes a state to which link information is set, the output unit 250 also acquires a rule series associated by the link information as a rule series being reachable to a target state from the observed state.

When a rule series is not acquired in Step S104 (N in Step S105), the output unit 250 executes, for example, predetermined error processing (Step S116) and terminates the processing. Herein, the output unit 250 outputs, for example, information indicating that “target state is unreached” to an administrator or the like as the predetermined error processing. Further, the output unit 250 may terminate a telephone call between the user and the partner by the input device 100 as the predetermined error processing.

When a rule series is acquired in Step S104 (Y in Step S105), the output unit 250 determines whether the observed state is a state at or before a starting point of a necessary rule series in the acquired rule series (Step S106).

When the observed state is a state after the starting point of the necessary rule series (N in Step S106), the output unit 250 executes, for example, the above-described predetermined error processing.

When the observed state is a state at or before the starting point of the necessary rule series (Y in Step S106), the output unit 250 sets the acquired rule series as a rule series in processing.

Next, the output unit 250 sets the next state following the observed state in the rule series in processing as a state in processing (Step S107).

The output unit 250 determines whether the state in processing is the target state (Step S108).

When the state in processing is the target state in Step S108 (Y in Step S108), the output unit 250 executes predetermined success processing (Step S117). Herein, the output unit 250 outputs, for example, information indicating that “target state is reached” to the administrator or the like as the predetermined success processing.

When the state in processing is not the target state in Step S108 (N in Step S108), the output unit 250 determines whether the state in processing is a state related to a message from the user (Step S109).

When the state in processing is a state related to a message from the user in Step S109 (Y in Step S109), the output unit 250 decides information indicating a message to be spoken by the user, based on the state in processing, and outputs the information to the output device 300 (Step S110).

Next, the analysis unit 210 extracts a sentence indicating a message from the user or the communication partner, similarly to Step S101 (Step S111).

The identification unit 220 identifies an observed state in the domain knowledge information, similarly to Step S102 (Step S112).

When an observed state is not identified in Step S112 (N in Step S113), the output unit 250 executes, for example, the above-described predetermined error processing (Step S116).

When an observed state is identified in Step S112 (Y in Step S113), the output unit 250 determines whether the observed state is identical to the state in processing (Step S114).

When the observed state is identical to the state in processing in Step S113 (Y in Step S114), the processing from Step S107 is repeated.

When the observed state is different from the state in processing in Step S113 (N in Step S114), the output unit 250 determines whether the observed state is a state associated with the state in processing by the link information (Step S115).

When the observed state is a state associated by the link information in Step S115 (Y in Step S115), the processing from Step S107 is repeated.

When the observed state is not a state associated by the link information in Step S115 (N in Step S115), the output unit 250 executes, for example, the above-described predetermined error processing (Step S116).

Next, a specific example of the first example embodiment of the present invention is described.

It is assumed herein that the domain knowledge information as in FIG. 5 is stored in the storage unit 230. It is also assumed that a state ‘a’ where “user meets unknown person while having cash” is identified by the identification unit 220 as an observed state, based on a message from a user or a communication partner.

The output unit 250 acquires the rule series “a→b→c→d→e→f” being reachable to a target state (state ‘f’) from the observed state (state ‘a’) and the rule series “g→h→i→j” being reachable to a target state (state ‘j’). Since the observed state (state ‘a’) is before a starting point (state ‘c’) of the necessary rule series, the output unit 250 sets the rule series “a→b→c→d→e→f” and “g→h→i→j” as a rule series in processing, and sets the next state ‘b’ where “user asks time and place” following the observed state, as a state in processing. Since the state in processing (state ‘b’) is a state related to a message from the user, the output unit 250 outputs, for example, information indicating a message to be spoken by the user “ask time and place” to the output device 300.

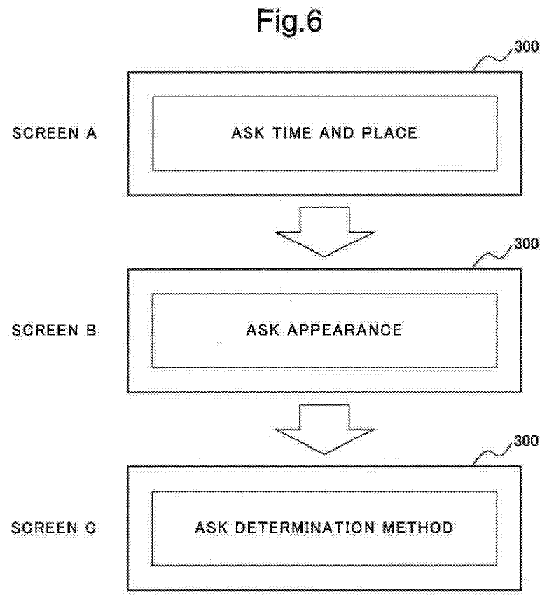

FIG. 6 is a diagram illustrating an example of a display screen of the output device 300 in the first example embodiment of the present invention.

As illustrated in a screen A in FIG. 6, the output device 300 displays the information output from the information output system 200 “ASK TIME AND PLACE” to the user. In this way, the user is led to ask the partner time and a place.

Next, it is assumed that the identification unit 220 identifies the state ‘b’ as the observed state because the user has asked the partner the time and the place. The output unit 250 sets the next state ‘c’ where “partner answers time and place” following the observed state, as the state in processing.

Next, it is assumed that the identification unit 220 identifies the state ‘c’ as the observed state because the partner has answered the time and the place. The output unit 250 sets the next state ‘d’ where “user asks appearance” following the observed state, as the state in processing. Since the state in processing (state ‘d’) is a state related to a message from the user, the output unit 250 outputs, for example, information indicating a message to be spoken by the user “ask appearance” to the output device 300.

As illustrated in a screen B in FIG. 6, the output device 300 displays the information output from the information output system 200 “ASK APPEARANCE” to the user. In this way, the user is led to ask the partner an appearance.

Next, it is assumed that the identification unit 220 identifies the state ‘d’ as the observed state because the user has asked the partner the appearance. The output unit 250 sets the next state ‘e’ where “partner answers appearance” following the observed state, as the state in processing.

Next, it is assumed that the identification unit 220 identifies the state ‘e’ as the observed state because the partner has answered the appearance. The output unit 250 sets the next state ‘f’ following the observed state, as the state in processing. Since the state ‘f’ is the target state (where time, place, and appearance are acquired), the output unit 250 outputs that “target state is reached” to the administrator or the like and terminates the processing.

On the other hand, it is assumed that the identification unit 220 identifies a state ‘g’ where “partner does not answer appearance” as the observed state because the partner has answered other than an appearance when the state in processing is the state ‘e’. In this case, the observed state (state ‘g’) is not the state in processing and is a state associated with the state in processing (state ‘e’) by the link information. The output unit 250 sets the next state ‘h’ where “user asks distinguishing method” following the observed state, as the state in processing. Since the state in processing (state ‘h’)) is a state related to a message from the user, the output unit 250 outputs, for example, information indicating a message to be spoken by the user “ask distinguishing method” to the output device 300.

As illustrated in a screen C in FIG. 6, the output device 300 displays the information output from the information output system 200 “ASK DISTINGUISHING METHOD” to the user. In this way, the user is led to ask the partner a distinguishing method.

Next, it is assumed that the identification unit 220 identifies the state ‘h’ as the observed state because the user has asked the partner the distinguishing method. The output unit 250 sets the next state ‘i’ where “partner answers distinguishing method” following the observed state, as the state in processing.

Next, it is assumed that the identification unit 220 has identified the state ‘i’ as the observed state because the partner has answered the distinguishing method. The output unit 250 sets the next state ‘j’ following the observed state, as the state in processing. Since the state ‘j’ is the target state (where time, place, and distinguishing method are acquired), the output unit 250 outputs that “target state is reached” to the administrator or the like and terminates the processing.

As described above, the operation in the first example embodiment of the present invention is completed.

Note that, in the first example embodiment of the present invention, a case where crime to be investigated is a fraud via telephone call (special fraud) is described as an example. However, the present invention is not limited to this, and crime to be investigated may be crime other than a fraud, such as fraudulent solicitation or a threat using communication means, as long as communication with a suspect using communication means occurs in the crime.

Further, in the first example embodiment of the present invention, “a state where information needed for investigation is acquired (state where the investigation can be started)” is set as a target state in domain knowledge information. However, the present invention is not limited to this, and another state, such as “a state where a user makes contact with a partner” or “a state where a partner is at a specific place”, may be set as a target state, as long as the state is needed for the investigation.

Further, in the first example embodiment of the present invention, a case where the communication means is a telephone call is described as an example, but the communication means may be other than a telephone call. For example, the communication means may be communication using text, such as e-mail, an online chat, an online bulletin board, or an SNS. In this case, the input device 100 and the output device 300 may be included in, for example, a user terminal such as a smartphone or a personal computer. Further, in this case, the input device 100 may input text data during communication between a user and a communication partner to the information output system 200. Further, the output device 300 may display information indicating a message to be sent by the user on a display screen during communication using the text, to the user.

Further, in the first example embodiment of the present invention, information indicating a message from a user is decided based on the next state following an observed state in a rule series. However, the present invention is not limited to this, and information indicating a message from the user may be decided based on another state, such as an arbitrary state related to a message from the user between the observed state and the target state in a rule series, as long as the target state is reached.

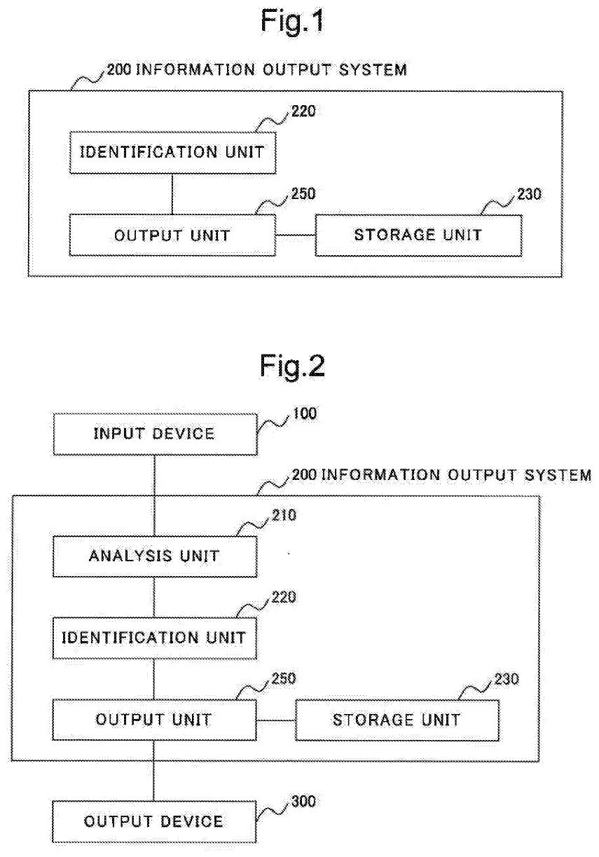

Next, a characteristic configuration of the first example embodiment of the present invention is described. FIG. 1 is a block diagram illustrating the characteristic configuration of the first example embodiment of the present invention.

With reference to FIG. 1, an information output system 200 includes an identification unit 220, a storage unit 230, and an output unit 250. The identification unit 220 identifies an observed state, based on information indicating a message from a person. The storage unit 230 stores knowledge information to be used for reasoning of a target state being a predetermined state for investigation. The output unit 250 performs reasoning, based on observation information indicating the observed state and the knowledge information, and outputs information indicating a message to be spoken or sent by the person.

Next, an advantageous effect of the first example embodiment of the present invention is described.

According to the first example embodiment of the present invention, a person can be led in such a way as to rapidly achieve a predetermined state for investigation of crime using communication means. The reason is that the information output system 200 performs reasoning, based on observation information and knowledge information needed for reasoning of a target state being a predetermined state for the investigation, and outputs information indicating a message to be spoken or sent by the person.

Further, according to the first example embodiment of the present invention, a person can be led in such a way as to rapidly achieve a predetermined state for investigation through a natural conversation. The reason is that the information output system 200 acquires a rule series (knowledge series) being reachable to a target state by reasoning, and determines a message to be spoken or sent by the person, based on a state related to a rule (knowledge) acquired in order from the rule series. The person can be led with a natural conversation by setting a state corresponding to a message in an order that makes the conversation natural, in a rule series.

### Second Example Embodiment

Next, a second example embodiment of the present invention is described.

The second example embodiment of the present invention is different from the first example embodiment of the present invention in that a lacking rule (knowledge) is generated to perform reasoning.

First, a configuration of the second example embodiment of the present invention is described.

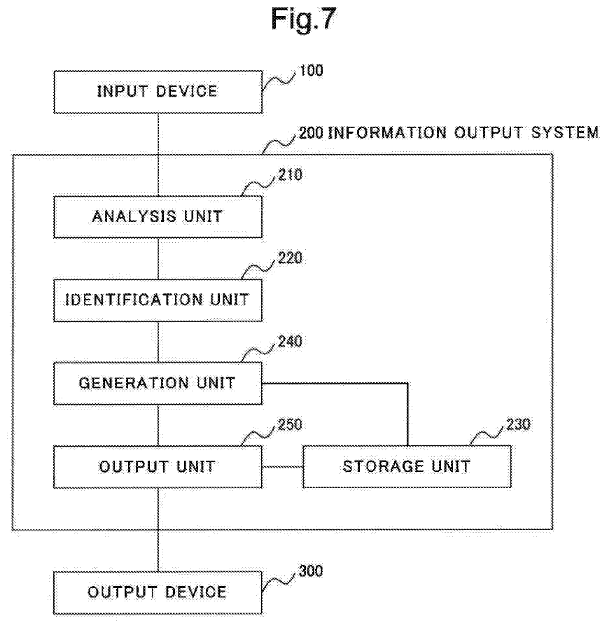

FIG. 7 is a block diagram illustrating a configuration of the second example embodiment of the present invention. With reference to FIG. 7, the information output system 200 in the second example embodiment of the present invention includes a generation unit 240 in addition to the components of the information output system 200 in the first example embodiment of the present invention.

The generation unit 240 generates a rule candidate, based on observation information and domain knowledge information. The rule candidate is a candidate for a rule that is not present in the domain knowledge information and is needed to reach a target state from an observed state. The generation unit 240 further calculates a score of feasibility of each generated rule candidate by using a model indicating feasibility of a relationship between states, and selects a new rule based on the calculated score. The model may be, for example, learned based on a known rule included in the domain knowledge information or learned based on a known rule widely collected from other than the domain knowledge information.

The storage unit 230 further stores the model in addition to the domain knowledge information. The model is input by an administrator or the like and stored in the storage unit 230, beforehand, for example.

The output unit 250 adds a new rule to the domain knowledge information to perform reasoning.

Next, operation in the second example embodiment of the present invention is described.

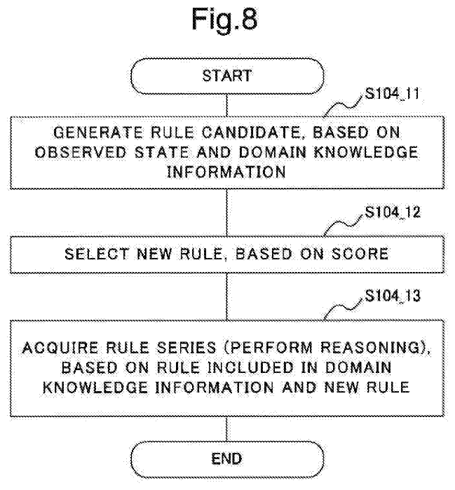

FIG. 8 is a flowchart illustrating details of reasoning processing (Step S104) in the second example embodiment of the present invention.

The generation unit 240 generates a rule candidate, based on an observed state and domain knowledge information (Step S104_11).

Herein, the generation unit 240 identifies a state being reachable from the state to a target state, for example, by following (tracing) rules from the target state in an opposite direction (a direction from a result to a premise) in the domain knowledge information. Then, the generation unit 240 generates, for each combination of the observed state and each identified state, a rule candidate in which the observed state is a premise and the identified state is a result.

The generation unit 240 calculates a score indicating feasibility of each rule candidate generated in Step S104_11 by using the model, and selects a new rule, based on the calculated score (Step S104_12). Herein, the generation unit 240 selects a rule candidate having a score equal to or more than a predetermined threshold value as a new rule.

As a method for calculating such a score, the technique described in NPL 3 or a technique for comparing similarity of states between a rule candidate and a known rule are used, for example.

When the technique described in NPL 3 is used, the generation unit 240 calculates a score of a rule candidate by using a vector that indicates a state related to the rule candidate and a weighting matrix indicated by a model. In this case, a score between states ‘a’ and ‘b’ is calculated, by using vectors Va, Vb and a weighting matrix W, with Va^{T}·W·Vb (where T represents transposition). The vectors Va and Vb respectively represent the states ‘a’ and ‘b’. The vectors Va and Vb are vectors having D dimensions, for example. Each element in the vectors Va and Vb corresponds to each word in a vocabulary dictionary including the D numbers of words. Each element represents presence or absence of a corresponding word in description indicating the state ‘a’ or ‘b’. The weighting matrix W is a matrix having D×D dimensions. The weighting matrix W is learned in such a way that a high score is calculated for a known rule included in the domain knowledge information and a known rule widely collected from other than the domain knowledge information.

The output unit 250 acquires a rule series being reachable to the target state from the observed state (performs reasoning), based on the rule included in the domain knowledge information and the new rule selected in Step S104_12 (Step S104_13).

Hereinafter, the processing on and after Step S105 is performed by using the acquired rule series.

Next, a specific example of the second example embodiment of the present invention is described.

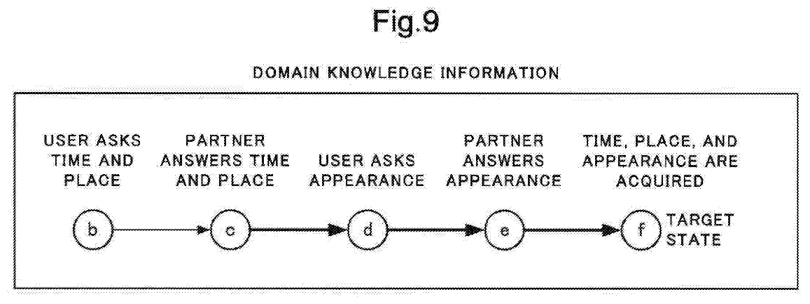

FIG. 9 is a diagram illustrating an example of domain knowledge information in the second example embodiment of the present invention. The domain knowledge information in FIG. 9 is different from the domain knowledge information in FIG. 5 in that a rule related to the state ‘a’ is not set. It is assumed herein that the domain knowledge information as in FIG. 9 is stored in the storage unit 230.

It is also assumed that a model indicating rules “meet unknown person→ask time and place”, “meet unknown person→ask appearance”, and “meet unknown person→ask distinguishing method” in descending order of scores is stored as a model in the storage unit 230.

It is also assumed that an identification unit 220 identifies the state ‘a’ where “user meets unknown person while having cash” as an observed state, based on a message from a user or a communication partner.

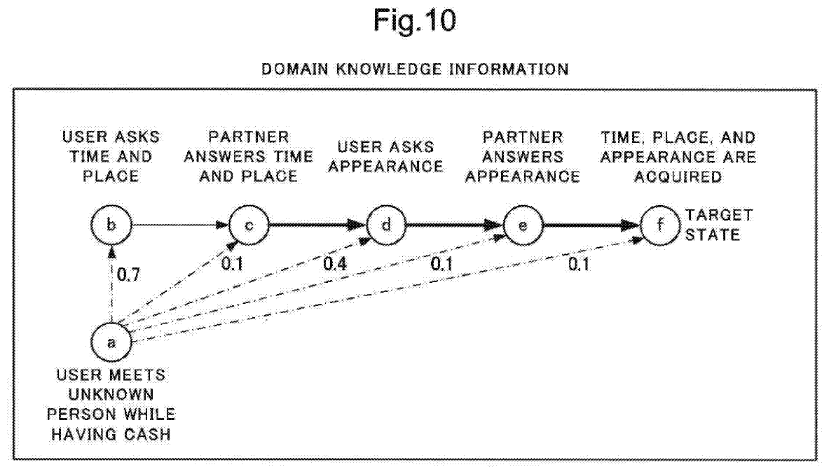

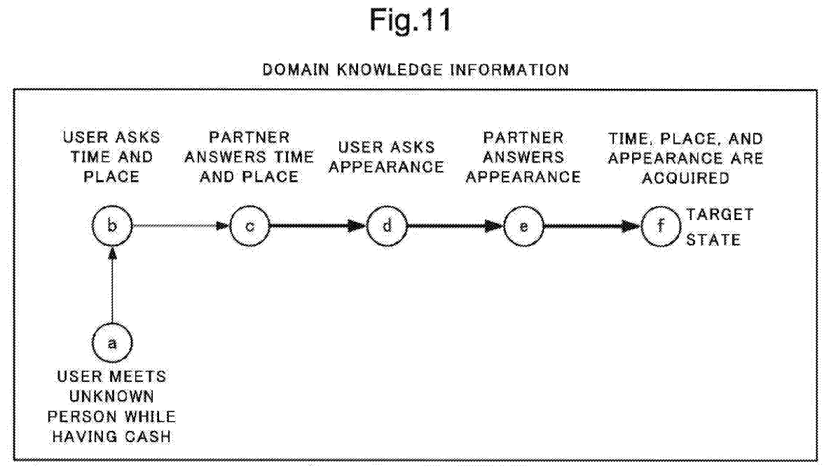

FIG. 10 is a diagram illustrating an example of generating a rule candidate related to the domain knowledge information in the second example embodiment of the present invention. In FIG. 10, an arrow in a dot-and-dash line indicates a generated rule candidate. A numerical value provided to the dot-and-dash line indicates a score of each rule candidate. Further, FIG. 11 is a diagram illustrating an example of selecting a new rule related to the domain knowledge information in the second example embodiment of the present invention.

As illustrated in FIG. 10, the generation unit 240 extracts a combination of the observed state (state ‘a’) and each state acquired by following (tracing) rules from the target state (state ‘f’) in an opposite direction as a rule candidate.

The generation unit 240 calculates a score of each rule candidate as illustrated in FIG. 10 by using the model. Herein, when a threshold value of a score for determining that a rule candidate is feasible is “0.5”, the generation unit 240 selects a rule candidate “a→b” having a feasibility score of “0.7” as a new rule, as illustrated in FIG. 11.

The output unit 250 acquires a rule series “a→b→c→d→e→f” being reachable to the target state (state ‘f’) from the observed state (state ‘a’) by using the domain knowledge information and the new rule, as in FIG. 11.

Hereinafter, the output unit 250 outputs information indicating a message to be spoken by the user in such a way that the target state ‘f’ can be achieved by using the rule series “a→b→c→d→e→f”, similarly to the first example embodiment of the present invention.

As described above, the operation in the second example embodiment of the present invention is completed.

Note that, in the second example embodiment of the present invention, a rule candidate is generated between an observed state and each state identified by following rules from a target state in an opposite direction in domain knowledge information. However, the present invention is not limited to this, and a rule candidate may be generated between each state identified by following rules from the observed state in a forward direction (direction from a premise to a result) and each state identified by following rules from the target state in the opposite direction in the domain knowledge information.

Next, an advantageous effect of the second example embodiment of the present invention is described.

According to the second example embodiment of the present invention, a person can be led in such a way as to rapidly achieve a predetermined state for investigation even when a rule is insufficient in domain knowledge information. The reason is that the generation unit 240 generates new knowledge, based on knowledge information, and the output unit 250 adds the new knowledge as knowledge in the knowledge information to perform reasoning.

### Third Example Embodiment

Next, a third example embodiment of the present invention is described.

The third example embodiment of the present invention is different from the second example embodiment of the present invention in that occurrence of crime to be investigated is unknown, and a message from a user is led after detecting the occurrence of the crime to be investigated.

In the third example embodiment of the present invention, knowledge information for general purpose use (hereinafter also referred to as general-purpose knowledge information) that is knowledge information for a region wider than that of domain knowledge information is used for detecting occurrence of crime to be investigated, for example.

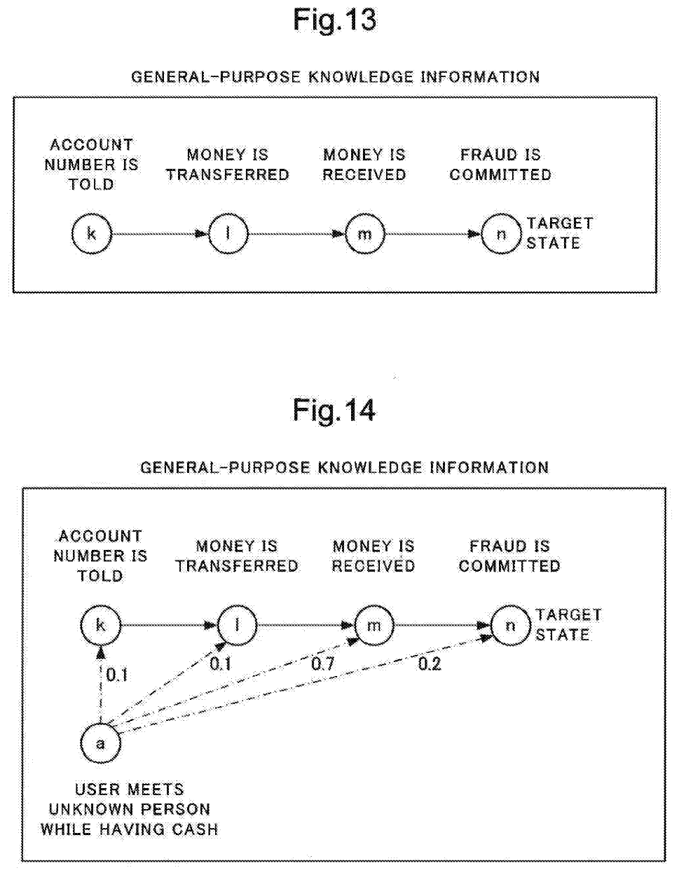

FIG. 13 is a diagram illustrating an example of general-purpose knowledge information in the third example embodiment of the present invention.

As illustrated in FIG. 13, the general-purpose knowledge information includes a state where a crime to be investigated occurs (“fraud is committed”) as a target state. Further, a rule series “k→l→m→n” is set as a rule series being reachable to the target state ‘n’.

Next, a configuration of the third example embodiment of the present invention is described. A block diagram illustrating the configuration of the third example embodiment of the present invention is similar to that of the second example embodiment of the present invention (FIG. 7).

The storage unit 230 further stores the general-purpose knowledge information in addition to domain knowledge information and a model. The general-purpose knowledge information is input by an administrator or the like and stored in the storage unit 230, beforehand, for example.

The generation unit 240 further generates a new rule related to the general-purpose knowledge information, based on the observed state and the general-purpose knowledge information.

The output unit 250 further performs reasoning by using the general-purpose knowledge information, and detects occurrence of crime to be investigated (“fraud is committed”) based on the observed state.

Next, operation in the third example embodiment of the present invention is described.

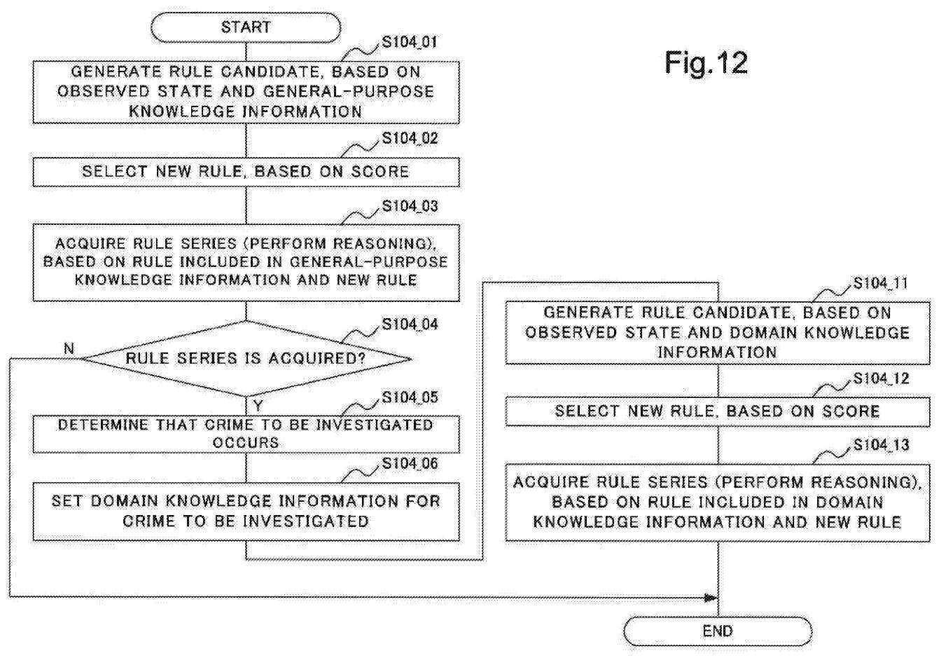

FIG. 12 is a flowchart illustrating details of reasoning processing (Step S104) in the third example embodiment of the present invention.

The generation unit 240 generates a rule candidate, based on an observed state and general-purpose knowledge information, similarly to Step S104_11 described above (Step S104_01). Herein, the generation unit 240 identifies a state being reachable from the state to the target state, by following (tracing) rules from the target state in an opposite direction (a direction from a result to a premise) in the general-purpose knowledge information. Then, the generation unit 240 generates, for each combination of the observed state and each identified state, a rule candidate in which the observed state is a premise and the identified states is a result.

The generation unit 240 calculates a score indicating feasibility of each rule candidate generated in Step S104_01 by using the model, and selects a new rule, based on the calculated score, similarly to Step S104_12 described above (Step S104_02). Herein, the generation unit 240 selects a rule candidate having a score equal to or more than a predetermined threshold value as a new rule.

The output unit 250 acquires a rule series being reachable to the target state from the observed state (performs reasoning), based on the rule included in the general-purpose knowledge information and the new rule selected in Step S104_02 (Step S104_03).

When the rule series is acquired in Step S104_03 (Y in Step S104_04), the output unit 250 determines that crime to be investigated occurs (“fraud is committed”) (Step S104_05).

The output unit 250 sets domain knowledge information for the crime to be investigated (“special fraud”) as domain knowledge information to be used in the following processing (Step S104_06).

Hereinafter, the generation unit 240 generates a new rule related to the domain knowledge information, similarly to the second example embodiment of the present invention (Steps S104_11 and S104_12). Further, the output unit 250 acquires a rule series being reachable to a target state from the observed state (performs reasoning), based on the rule included in the domain knowledge information and the new rule (Step S104_13).

Then, the processing on and after Step S105 is performed by using the acquired rule series.

Next, a specific example of the third example embodiment of the present invention is described.

It is assumed herein that the general-purpose knowledge information as in FIG. 13 and the domain knowledge information as in FIG. 9 are stored in the storage unit 230. It is also assumed that a model indicating a high score for a rule “meet unknown person while having cash→cash is delivered” is stored as a model in the storage unit 230.

It is also assumed that the identification unit 220 identifies a state ‘a’ where “user meets unknown person while having cash” as an observed state, based on a message from a user or a communication partner.

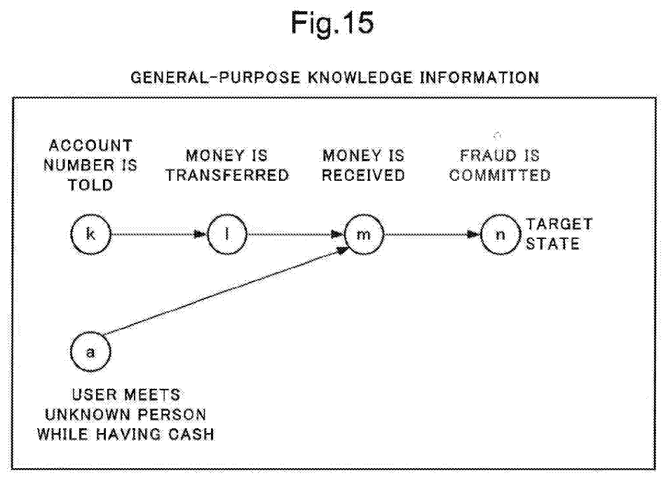

FIG. 14 is a diagram illustrating an example of generating a rule candidate related to the general-purpose knowledge information in the third example embodiment of the present invention. In FIG. 14, an arrow in a dot-and-dash line indicates a generated rule candidate. Further, a numerical value provided to the dot-and-dash line indicates a score of each rule candidate. Further, FIG. 15 is a diagram illustrating an example of selecting a new rule related to the general-purpose knowledge information in the third example embodiment of the present invention.

As illustrated in FIG. 14, the generation unit 240 extracts a combination of the observed state (state ‘a’) and each state acquired by following (tracing) rules from the target state (state ‘n’) in an opposite direction as a rule candidate.

The generation unit 240 calculates a score of each rule candidate as illustrated in FIG. 14 by using the model. Herein, when a threshold value of a score for determining that a rule candidate is feasible is “0.5”, the generation unit 240 selects a rule candidate “a→m” having a feasibility score of “0.7” as a new rule related to the general-purpose knowledge information, as illustrated in FIG. 15.

The output unit 250 acquires a rule series “a→m→n” being reachable to the target state (state ‘n’) from the observed state (state ‘a’) by using the general-purpose knowledge information and the new rule, as in FIG. 15, and determines that “fraud is committed (occurs)”.

The output unit 250 sets domain knowledge information for “investigation of special fraud” as domain knowledge information to be used.

Hereinafter, as illustrated in FIG. 11, the generation unit 240 generates a new rule “a→b” related to the domain knowledge information, and the output unit 250 outputs information indicating a message to be spoken by the user in such a way that the target state ‘f’ can be achieved by using the rule series “a→b→c→d→e→f”.

As described above, the operation in the third example embodiment of the present invention is completed.

Note that, in the third example embodiment of the present invention, a case where the generation unit 240 generates new rules related to the domain knowledge information and the general-purpose knowledge information is described as an example. However, the present invention is not limited to this, and generation of new rules by the generation unit 240 may be omitted as long as a target state can be reached from an observed state with rules included in the domain knowledge information and the general-purpose knowledge information, similarly to the first example embodiment of the present invention.

Further, in the third example embodiment of the present invention, a case where the number of types of crime to be detected is one is described as an example. However, the present invention is not limited to this, and a plurality of types may be used as types of crime to be detected. In this case, the output unit 250 performs reasoning by using general-purpose knowledge information including a target state for each of the plurality of types of crime, and identifies a type of occurring crime. Then, the output unit 250 outputs information indicating a message to be spoken by a user by using domain knowledge information for the identified type of crime.

Next, an advantageous effect of the third example embodiment of the present invention is described.

According to the third example embodiment of the present invention, it is possible to detect occurrence of crime to be investigated and lead a person in such a way as to acquire information needed for the investigation, even when occurrence of crime to be investigated is unknown. The reason is that the information output system 200 performs reasoning of “a state where crime to be investigated is occurring”, and, when “the state where crime to be investigated is occurring” is detected from the result of the reasoning, performs reasoning of “a state where information needed to start the investigation is acquired”.

While the present invention has been particularly shown and described with reference to the example embodiments thereof, the present invention is not limited to the embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2016-136828, filed on Jul. 11, 2016, the disclosure of which is incorporated herein in its entirety by reference.

### INDUSTRIAL APPLICABILITY

The present invention is widely applicable to a telephone, a user terminal, a server connected to the telephone and the user terminal, and the like that are likely to be used in crime using communication means.

### REFERENCE SIGNS LIST

100 Input device
200 Information output system
201 CPU
202 Storage device
203 Input-output device
204 Communication device
210 Analysis unit
220 Identification unit
230 Storage unit
240 Generation unit
250 Output unit
300 Output device

1. A knowledge information generation system, comprising:
a storage that stores knowledge information to be used for reasoning of a target state being a predetermined state for investigation, and a model indicating feasibility of relevance between states;
a memory that stores a set of instructions; and
at least one processor configured to execute the set of instructions to:
identify an observed state, based on information indicating a message from a person; and
generate new knowledge to be added to the knowledge information based on the knowledge information, the model, the observed state, and the target state.

2. The knowledge information generation system according to claim 1, wherein the at least one processor is further configured to execute the set of instructions to input the new knowledge being generated into an output unit which performs reasoning, based on observation information indicating the observed state and the knowledge information, and outputs information indicating a message to be spoken or sent by the person.

3. The knowledge information generation system according to claim 1, wherein
the knowledge information indicates relevance of a premise and a result between the states, and
the at least one processor is further configured to execute the set of instructions to generate the new knowledge by tracing the states from the target state in a direction from the result to the premise in the knowledge information.

4. The knowledge information generation system according to claim 1, wherein
the knowledge information indicates relevance of a premise and a result between the states, and
the at least one processor is further configured to execute the set of instructions to generate the new knowledge by following the states from the observed state in a direction from the premise to the result in the knowledge information.

5. The knowledge information generation system according to claim 1, wherein the at least one processor is further configured to execute the set of instructions to generate the new knowledge having a score equal to or more than a threshold value by calculating the score indicating the feasibility based on the model.

6. The knowledge information generation system according to claim 5, wherein the at least one processor is further configured to execute the set of instructions to calculate the score based on a vector that indicates the state and a weighting matrix indicated by the model.

7. The knowledge information generation system according to claim 6, wherein
the vector has D (D is any integer) dimensions and represents presence or absence of each of words in description indicating the state, the each of words being included in a vocabulary dictionary which has the D numbers of words, and
the weighting matrix has D x D dimensions.

8. The knowledge information generation system according to claim 6, wherein
the model indicates a result of being learned based on known knowledge, and
the weighting matrix indicates values in such a way that the score is high for the known knowledge.

9. A knowledge information generation method, comprising:
by an information processing device,
storing knowledge information to be used for reasoning of a target state being a predetermined state for investigation, and a model indicating feasibility of relevance between states, in a storage;
identifying an observed state, based on information indicating a message from a person; and
generating new knowledge to be added to the knowledge information based on the knowledge information, the model, the observed state, and the target state.

10. The knowledge information generation method according to claim 9, wherein inputting the new knowledge being generated into an output unit which performs reasoning, based on observation information indicating the observed state and the knowledge information, and outputs information indicating a message to be spoken or sent by the person.

11. The knowledge information generation method according to claim 9, wherein
generating the new knowledge by tracing the states from the target state in a direction from the result to the premise in the knowledge information, the knowledge information indicating relevance of a premise and a result between the states.

12. The knowledge information generation method according to claim 9, wherein
generating the new knowledge by following the states from the observed state in a direction from the premise to the result in the knowledge information, the knowledge information indicating relevance of a premise and a result between the states.

13. The knowledge information generation method according to claim 9, wherein generating the new knowledge having a score equal to or more than a threshold value by calculating the score indicating the feasibility based on the model.

14. The knowledge information generation method according to claim 13, wherein calculating the score based on a vector that indicates the state and a weighting matrix indicated by the model.

15. A non-transitory computer-readable storage medium in which a program is stored, the program causing a computer to execute, the computer including a storage that stores knowledge information to be used for reasoning of a target state being a predetermined state for investigation, and a model indicating feasibility of relevance between states:
identifying an observed state, based on information indicating a message from a person; and
generating new knowledge to be added to the knowledge information based on the knowledge information, the model, the observed state, and the target state.

16. The non-transitory computer-readable storage medium according to claim 15, wherein the program causing the computer to execute inputting the new knowledge being generated into an output unit which performs reasoning, based on observation information indicating the observed state and the knowledge information, and outputs information indicating a message to be spoken or sent by the person.

17. The non-transitory computer-readable storage medium according to claim 15, wherein
the program causing the computer to execute generating the new knowledge by tracing the states from the target state in a direction from the result to the premise in the knowledge information, the knowledge information indicating relevance of a premise and a result between the states.

18. The non-transitory computer-readable storage medium according to claim 15, wherein
the program causing the computer to execute generating the new knowledge by following the states from the observed state in a direction from the premise to the result in the knowledge information, the knowledge information indicating relevance of a premise and a result between the states.

19. The non-transitory computer-readable storage medium according to claim 15, wherein the program causing the computer to execute generating the new knowledge having a score equal to or more than a threshold value by calculating the score indicating the feasibility based on the model.

20. The non-transitory computer-readable storage medium according to claim 19, wherein the program causing the computer to execute calculating the score based on a vector that indicates the state and a weighting matrix indicated by the model.
